(19) United States
(12) Patent Application Publication
(10) Pub. No.: US 2019/0163761 A1
(43) Pub. Date: May 30, 2019

(54) AUTOMATIC CUSTOMIZATION OF A GENERIC WEB INTERFACE

(71) Applicant: INTERNATIONAL BUSINESS MACHINES CORPORATION, ARMONK, NY (US)

(72) Inventors: Myriam Battelli, Rome (IT); Fabio Cerri, Rome (IT); Giuseppe Ciano, Rome (IT); Marco De Santis, Rome (IT); James H. Kim, Austin, TX (US); Alessandro Scotti, Rome (IT)

(21) Appl. No.: 15/825,300

(22) Filed: Nov. 29, 2017

(51) Int. Cl. G06F 17/30; G06F 17/21

(52) U.S. Cl. CPC G06F 17/3089; G06F 17/212; G06F 17/30905

(57) ABSTRACT

A computer accesses a target application to retrieve a plurality of target properties that correspond to a plurality of target styles of the target application and accesses a source to a plurality of source properties that correspond to a plurality of source styles of the source. Generating a target list that list the plurality of target properties and target styles, and generating a source list that list the plurality of source properties and source styles. Comparing the plurality of target styles from the target list to the plurality of source styles from the source. In response to matching some of the plurality of target styles to some of plurality of source styles, replacing the properties that correspond to the match plurality of target styles with the properties of the match plurality of source styles. Transmitting the replaced properties that correspond to the plurality of target styles.

### BACKGROUND

The present invention relates generally to the field of styling a website or an application, and more particularly to automatically customizing a new application or website based on a source.

Nowadays there is a great number of products offering a web interface, and this number is constantly increasing thanks also to cloud systems becoming more and more widespread. Customers can then use their browser to connect to and use applications hosted on a remote network system (e.g. on a cloud).

Some applications where customization is very important, for example asset management or service management applications are usually customized for a specific customer (i.e. company) to reflect the company visuals and terminology. For example, let's say that company X has an intranet portal for its employees, and in the intranet portal there is a link to a service management application that is provided and hosted by a third-party vendor on a cloud. When an employee starts this application, company X wants the application to have the company look not just a generic look.

Having a consistent look, in addition to satisfying company identity and policy requirements, is also very important from a usability perspective and increases user productivity and satisfaction. Right now, even if the application vendor provides a way for customizing its application, the customization work must be performed manually. This means that company X will have to allocate resources (people and money) in order to build a company theme to customize the web application. To make things worse, this customization could be necessary for more than one application, and all customizations need to be maintained over time.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for automatically implementing styles in a target application. A computer accesses a target application to retrieve a plurality of target properties that correspond to a plurality of target styles of the target application. The computer accesses a source to a plurality of source properties that correspond to a plurality of source styles of the source. Generating a target list that list the plurality of target properties that correspond to the plurality of target styles and generating a source list that list the plurality of source properties that correspond to the plurality of source styles. Comparing the plurality of target styles from the target list to the plurality of source styles from the source. In response to matching some of the plurality of target styles to some of plurality of source styles, replacing the properties that correspond to the match plurality of target styles with the properties of the match plurality of source styles. Transmitting the replaced properties that correspond to the plurality of target styles to the target application, thus the target application now displays the plurality of target styles that corresponds to the replaced properties.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating an automatic style setting processing environment, in accordance with an embodiment of the present invention.

FIG. 2 is a flowchart depicting operational steps of the automatic style setting within the automatic style setting processing environment of FIG. 1, in accordance with an embodiment of the present invention.

FIG. 3 is a block diagram of components of a computing device of the secure communication systems of FIG. 1, in accordance with embodiments of the present invention.

FIG. 4 depicts a cloud computing environment according to an embodiment of the present invention.

FIG. 5 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for establishing a style for a new application or website that is cohesive with previously establish material for a corporation. A new website or application is analyzed to establish a target list of styles that are needed for the application/website. A previously established application/website is analyzed to determine the different styles that are being used to establish a source list. Matching up elements of the target list and the source list to determine which element of the target list that are not found in the source list. Replacing the values of the items on the target list with values found on the source list. Generating a pending list for the items on the target list that did not have a matching item on the source list generating a value for each item that is found on the pending list. Determining a difference between the generated value for each item on the pending list and a value found on the pending list. Determining a property based on the determined difference and a source index. Transforming the determine property based source list and replacing the values on the target list with the value of transformed determine property. Updating the properties of the new application/website based on the replaced values on the target list, thus updating the appearance of the target application/website.

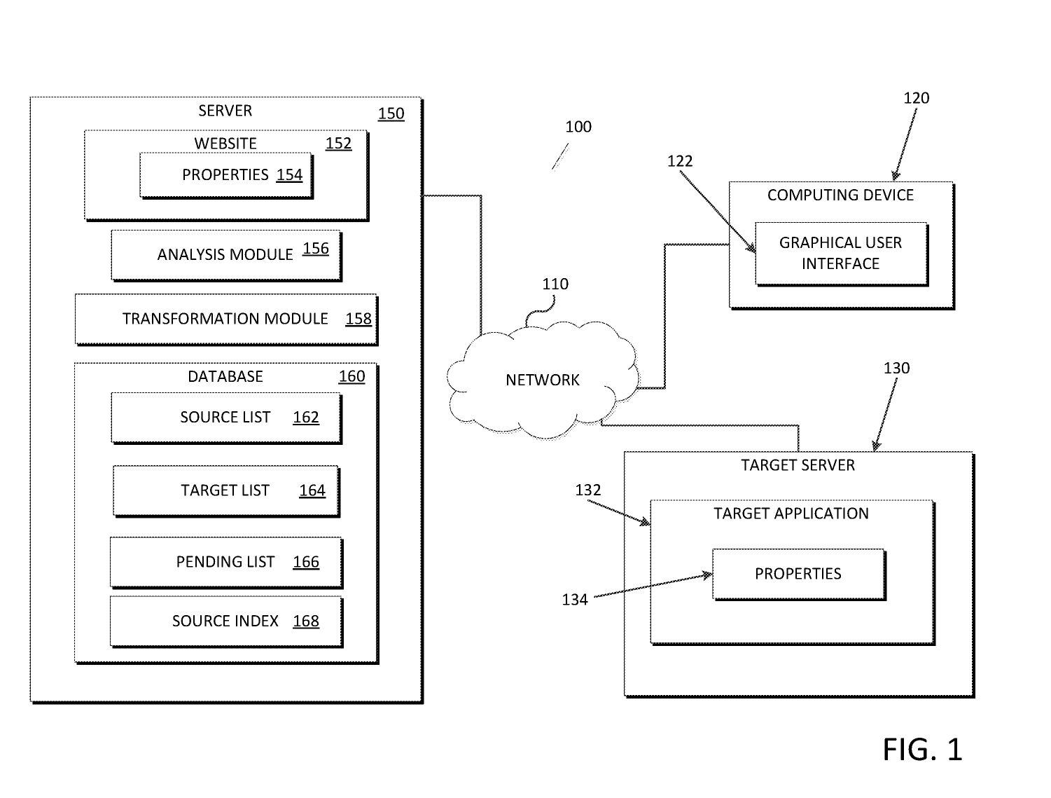

FIG. 1 is a functional block diagram illustrating an automatic style setting processing environment, in accordance with an embodiment of the present invention.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between computing device 120, target server 130 and server 150.

The computing device 120 represents a computing device that includes a user interface, for example, a graphical user interface 122. The graphical user interface 133 can be any type of interface that is able to access target application 132, and/or server 150 that allows a user to access, modify or alter the style of a website or an application.

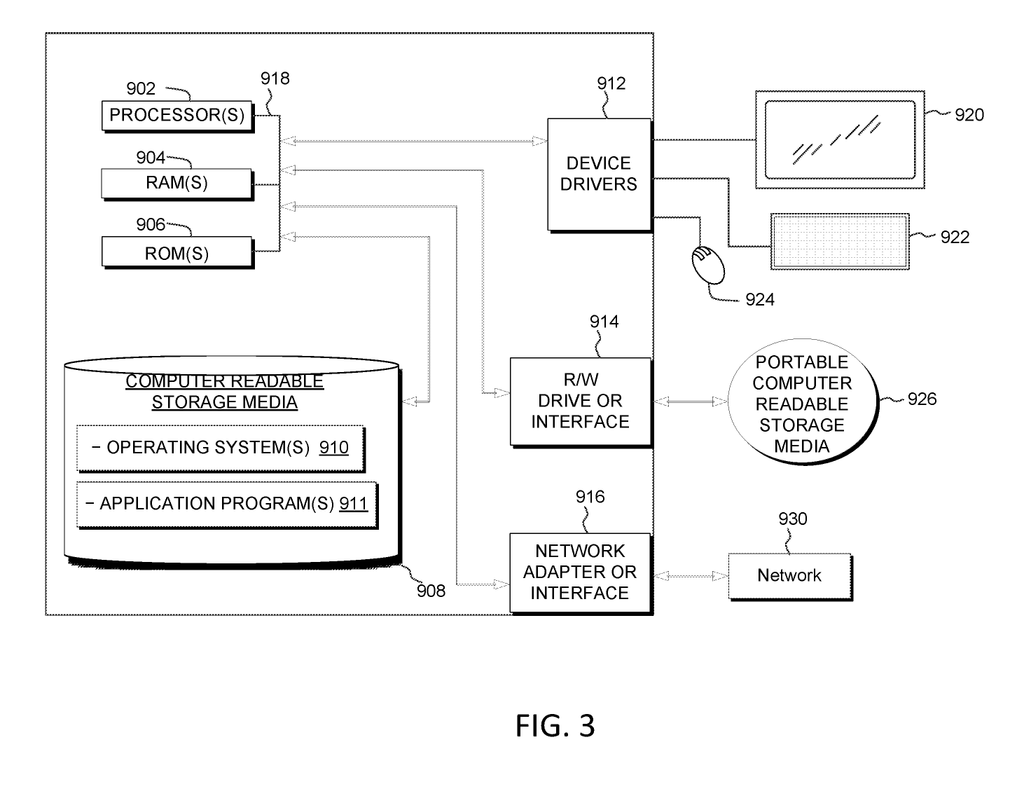

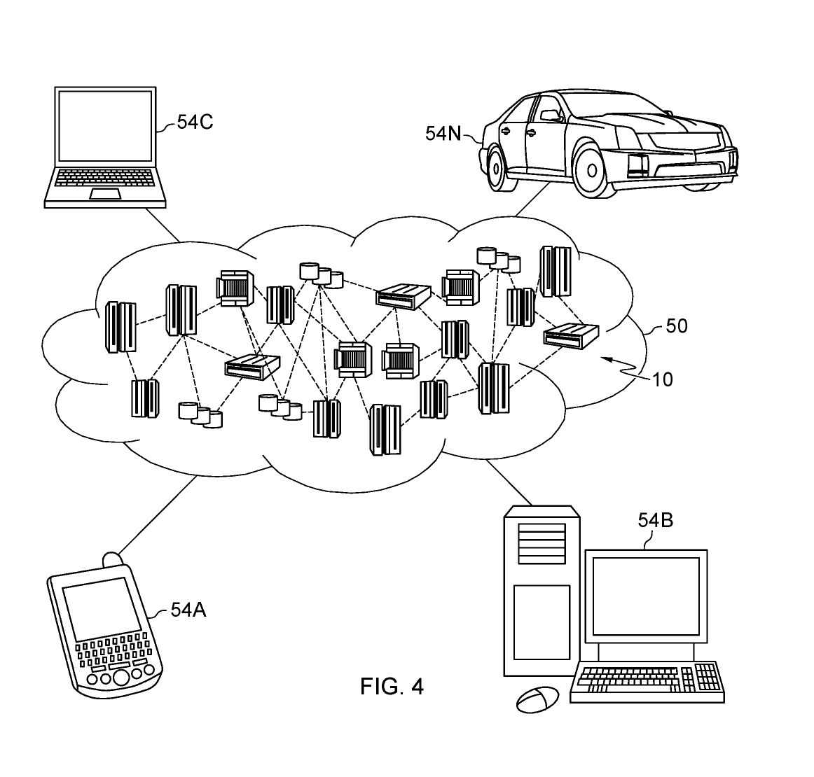

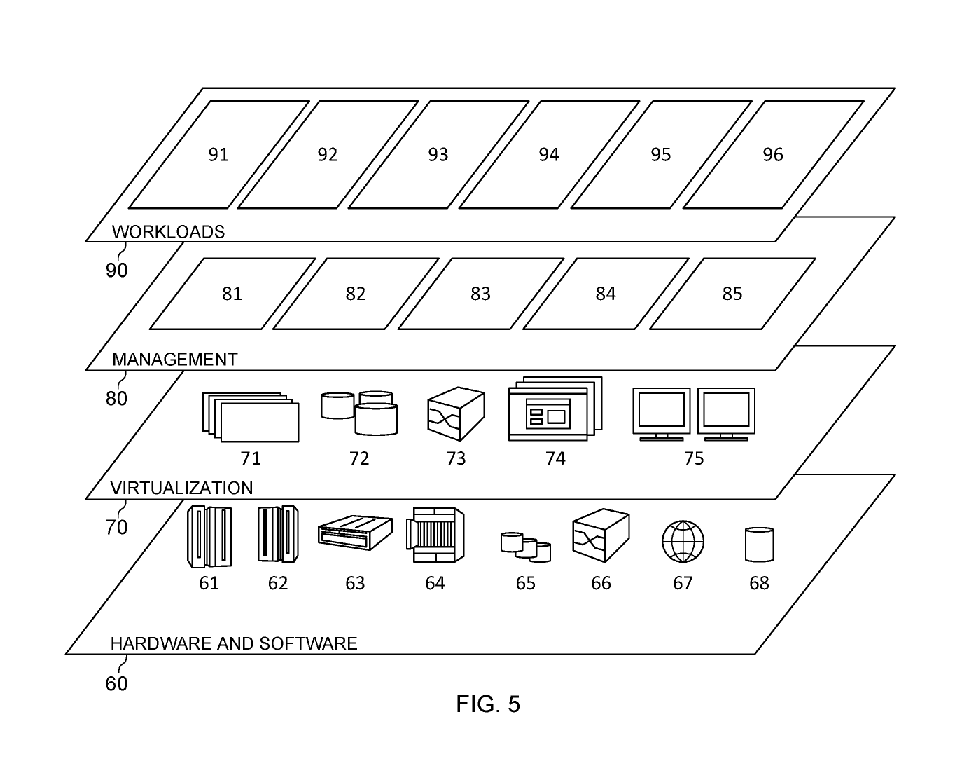

The computing device 120 may be any type of computing devices that are capable of connecting to network 110, for example, a laptop computer, tablet computer, netbook computer, personal computer (PC), a desktop computer, a smart phone, or any programmable electronic device supporting the functionality required by one or more embodiments of the invention. The computing device 120 may include internal and external hardware components, as described in further detail below with respect to FIG. 3. In other embodiments, the computing device 120 may operate in a cloud computing environment, as described in further detail below with respect to FIGS. 4 and 5.

The target server 130 includes target application 132 and the properties 134 of target application 132. Target application 132 contains different styles and corresponding properties 134 to those styles. The present invention is not limited to just a target application 132, but can be utilized to establish the styles for a new website instead. Target server 130 may include internal and external hardware components, as depicted and described in further detail below with reference to FIG. 3. In other embodiments, the target server 130 may include internal and external hardware components, as depicted and described in further detail below with respect to FIG. 4, and operate in a cloud computing environment, as depicted in FIG. 5.

Server 150 includes a website 152, an analysis module 156, a transformation module 158, and a database 160. Website 152 has already been formatted with styles associated with a corporation, business or enterprise. Website 152 includes properties 154 that correspond to the formatted styles.

The analysis module 156 contains a plurality of plug-ins (not shown) to analyze the website 152 and target application 132. The analysis module 156 uses a plug-in that corresponds to the programing language of website 152 and that of target application 132. The analysis module 156 extracts a list of styles of the target application 132 and the correspond properties 134 to form the target list 164. The analysis module 156 extracts a list of formatted styles of website 152 and the corresponding properties 154 to form the source list 162.

The analysis module 156 compares the target list 164 and the source list 162 to determine which of the properties 134, 154 appear on both list but have different values. The analysis forms a pending list 166 from the properties 134 on the target list 164 that do not have a corresponding properties 154 on the source list 162. The analysis module 156 generates a value for each item on the pending list 166 and determines the difference between the generated value for each item on the pending list 166 and corresponding item on the target list 164. The analysis module determines a property based on the determined difference. The transformation module 158 the determined property based on a source index 168.

The transformation module 158 transform a property based on the source index 168. For example, if the new application a button in the main page is dark grey while the page background is grey, the transformation module 158 can say that there is a certain probability that if the background of the Website 152 main page is orange than a good choice for the color of a button on the main page is dark orange. Making the color dark is in this case the transformation.

There is a property 134 of the target application 132, for example, a menu which is not available in the source website 152. The analysis module 156 identifies how the value (color) of this property 134 is related to other properties 134 of the target application 132 so that the discovered relationships can be used to determine the actual value of the property 154 in the source website 152.

The analysis module 156 identifies possible relationships with other properties 134, 154 based on their similarities. The analysis module 156 iterates over these discovered properties 134 and the transformation module 158 applies a predefined set of transformations to calculate if they are good to evaluate the missing value (color distance). The transformation module 158 applies various transformation including reversing the color, changing the brightness etc. . . . the match in the example occurs for the change brightness transformation.

The database 160 is a data stores that includes the source list 162, the target list 164, the pending list 166, and the source index 168.

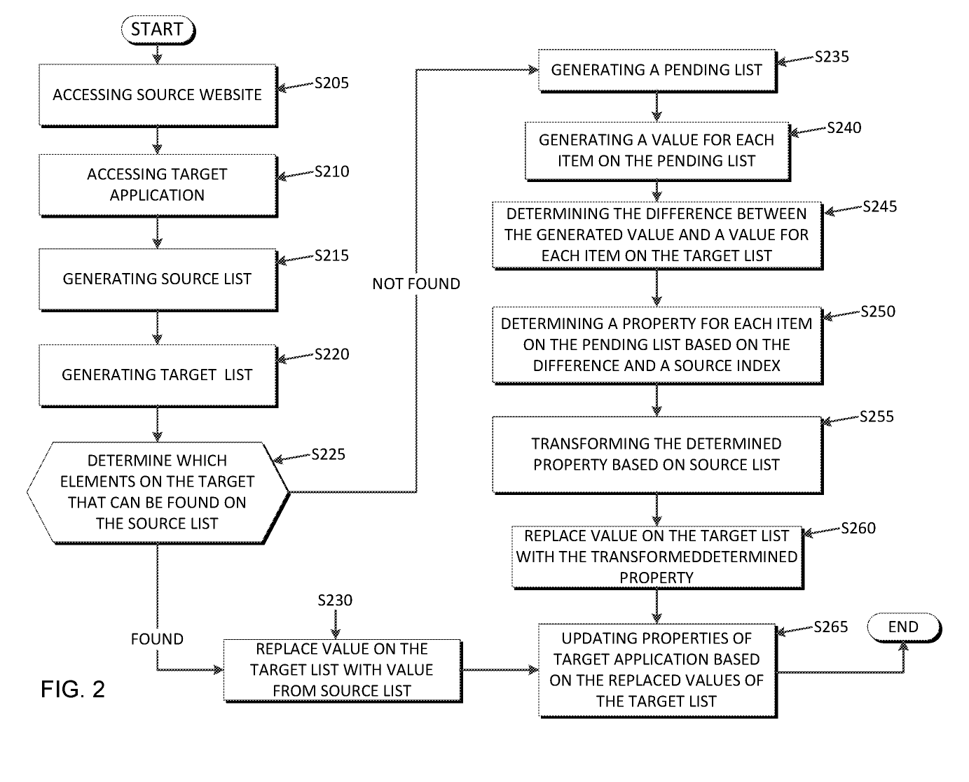

FIG. 2 is a flowchart depicting operational steps of the automatic style setting within the automatic style setting processing environment of FIG. 1, in accordance with an embodiment of the present invention.

The analysis module 156 access the source website 152 to get access to the formatted styles and their corresponding properties 154 (S205). The analysis module 156 access the target application 132 to get access to the styles and their corresponding properties 134 (S210). The analysis module 156 generates a source list 162 composed of the styles and their corresponding properties 154 (S215) and generates a target list 164 composed of the styles and their corresponding properties 134 (S220). The analysis module 156 compares the source list 162 and the target list 164 to determine if styles appear on both list (S225). When the style is found on both list, each property 134 corresponding to the matched style on the target list 164 is replace with the property 154 corresponding to the matched style on the source list 162 (S230).

When the styles on the target list 164 are not matched to a style on the source list 162, then the analysis module 156 generates a pending list 166 (S235). The analysis module 156 generates a value for each of the styles on the pending list 166 (S240). The analysis module 156 determines the difference between the generated values and a value for each of the styles on the target list 164 (S245). The analysis module 156 determines a property for each style on the pending list 166 based on the determined difference and a source index 168 (S250). The transformation module 158 transforms the determined property based on the source list 162 (S255). The analysis module 156 replaces the property 134 for each style on the target list 164 with the transformed property (S260). Server 150 transmits the updated properties on the target list 164 to the target application 132, thus the target application 132 now displays the styles that corresponds to the updated properties (S265).

FIG. 3 depicts a block diagram of components of automatic style setting processing environment 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Client computing device 120, target server 130 and/or server 150 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, analysis module 156 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Client computing device 120, target server 130 and/or server 150 may also include a R/W drive or interface 914 to read from and write to one or more portable computer readable storage media 926. Application programs 911 on client computing device 120, target server 130 and/or server 150 may be stored on one or more of the portable computer readable storage media 926, read via the respective R/W drive or interface 914 and loaded into the respective computer readable storage media 908.

Client computing device 120, target server 130 and/or server 150 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on client computing device 120, target server 130 and/or server 150 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Client computing device 120, target server 130 and/or server 150 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and automatically implementing styles in a new application/website using a previously establish source, for example, a previously establish website 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

1. A method for automatically implementing styles in a target application, the method comprising:
accessing, by a computer, a target application to retrieve a plurality of target properties that correspond to a plurality of target styles of the target application;
accessing, by the computer, a source to a plurality of source properties that correspond to a plurality of source styles of the source;
generating, by the computer, a target list that list the plurality of target properties that correspond to the plurality of target styles;
generating, by the computer, a source list that list the plurality of source properties that correspond to the plurality of source styles;
comparing, by the computer, the plurality of target styles from the target list to the plurality of source styles from the source list;
in response to not matching some of the plurality of target styles from the target list to some of the plurality of source styles from the source list, generating, by the computer, a pending list that includes target properties that do not match any of the plurality of source properties;
replacing the target properties in the pending list, that do not match any of the plurality of source properties, with a set of functions that can compute a similar value from other information in the target properties in the pending list, wherein the similar value for a replaced target property in the pending list is computed via a similarity index;
generating, by the computer, a value for each target style, from the plurality of target styles, on the pending list;
determining, by the computer, a difference between the generated value for each target style on the pending list to the corresponding property for each of the plurality of target styles from the target list;
determining, by the computer, a new property for each target style on the pending list based on the determined difference and the similarity index;
transforming, by the computer, the new property for each target style on the pending list based on the similarity index;
replacing, by the computer, the properties on the target list that correspond to the plurality of target styles on the pending list with the transformed new properties; and
transmitting, by the computer, the replaced transformed new properties, thus the target application now displays the plurality of target styles that corresponds to the replaced transformed new properties.

2. (canceled)

3. (canceled)

4. (canceled)

5. (canceled)

6. (canceled)

7. A computer program product for automatically implementing styles in a target application, the computer program product comprising:
one or more non-transitory computer-readable storage media and program instructions stored on the one or more non-transitory computer-readable storage media, the program instructions comprising:
accessing a target application to retrieve a plurality of target properties that correspond to a plurality of target styles of the target application;
accessing a source to a plurality of source properties that correspond to a plurality of source styles of the source;
generating a target list that list the plurality of target properties that correspond to the plurality of target styles;
generating a source list that list the plurality of source properties that correspond to the plurality of source styles;
comparing the plurality of target styles from the target list to the plurality of source styles from the source list;
in response to not matching some of the plurality of target styles from the target list to some of the plurality of source styles from the source list, generating a pending list that includes target properties that do not match any of the plurality of source properties;
replacing the target properties in the pending list, that do not match any of the plurality of source properties, with a set of functions that can compute a similar value from other information in the target properties in the pending list, wherein the similar value for a replaced target property in the pending list is computed via a similarity index;
generating a value for each target style, from the plurality of target styles, on the pending list;
determining a difference between the generated value for each target style on the pending list to the corresponding property for each of the plurality of target styles from the target list;
determining a new property for each target style on the pending list based on the determined difference and the similarity index;
transforming the new property for each target style on the pending list based on the similarity index;
replacing the properties on the target list that correspond to the plurality of target styles on the pending list with the transformed new properties; and
transmitting the replaced transformed new properties, thus the target application now displays the plurality of target styles that corresponds to the replaced transformed new properties.

8. (canceled)

9. (canceled)

10. (canceled)

11. (canceled)

12. (canceled)

13. A computer system for automatically implementing styles in a target application, the computer system comprising:
one or more computer processors, one or more computer-readable storage media, and program instructions stored on one or more of the computer-readable storage media for execution by at least one of the one or more processors, the program instructions comprising:
accessing a target application to retrieve a plurality of target properties that correspond to a plurality of target styles of the target application;
accessing a source to a plurality of source properties that correspond to a plurality of source styles of the source;
generating a target list that list the plurality of target properties that correspond to the plurality of target styles;
generating a source list that list the plurality of source properties that correspond to the plurality of source styles;
comparing the plurality of target styles from the target list to the plurality of source styles from the source list;
in response to not matching some of the plurality of target styles from the target list to some of the plurality of source styles from the source list, generating a pending list that includes target properties that do not match any of the plurality of source properties;
replacing the target properties in the pending list, that do not match any of the plurality of source properties, with a set of functions that can compute a similar value from other information in the target properties in the pending list, wherein the similar value for a replaced target property in the pending list is computed via a similarity index;
generating a value for each target style, from the plurality of target styles, on the pending list;
determining a difference between the generated value for each target style on the pending list to the corresponding property for each of the plurality of target styles from the target list;
determining a new property for each target style on the pending list based on the determined difference and the similarity index;
transforming the new property for each target style on the pending list based on the similarity index;
replacing the properties on the target list that correspond to the plurality of target styles on the pending list with the transformed new properties; and
transmitting the replaced transformed new properties, thus the target application now displays the plurality of target styles that corresponds to the replaced transformed new properties.

14. (canceled)

15. (canceled)

16. (canceled)

17. (canceled)

18. (canceled)

19. The method of claim 1, wherein the similarity index comprises:
one or more entries in the source list whose distance is less than a pre-defined factor away from the one or more target properties in the pending list.

20. The computer program product of claim 7, wherein the similarity index comprises:
one or more entries in the source list whose distance is less than a pre-defined factor away from the one or more target properties in the pending list.

21. The computer system of claim 13, wherein the similarity index comprises:
one or more entries in the source list whose distance is less than a pre-defined factor away from the one or more target properties in the pending list.
